(19) United States
(12) Patent Application Publication
(10) Pub. No.: US 2025/0209350 A1
(43) Pub. Date: Jun. 26, 2025

(54) METHOD AND APPARATUS FOR UPDATING KNOWLEDGE GRAPH

(71) Applicant: Alipay (Hangzhou) Information Technology Co., Ltd., Hangzhou (CN)

(72) Inventor: Zhengke GUI, Hangzhou (CN)

(21) Appl. No.: 18/849,346

(22) PCT Filed: Jan. 4, 2023
(86) PCT No.: PCT/CN2023/070482

§ 371 Date: Sep. 20, 2024

(30) Foreign Application Priority Data
Mar. 23, 2022 (CN) 202210290077.1

(51) Int. Cl. G06N 5/022

(52) U.S. Cl. CPC G06N 5/022

(57) ABSTRACT

The disclosure provides a method and an apparatus for updating a knowledge graph. In a process of providing knowledge graph-based data support for a current service, a knowledge graph is updated by combining online and offline manners. The knowledge graph is constructed offline by using full service data, and full entity linking and entity normalization are performed to initialize the knowledge graph. An incremental update condition is set to perform a plurality of rounds of incremental update. During one round of incremental update, real-time linking is performed based on service data generated in real time, to provide online knowledge graph update; and when the preset incremental update condition is met, incremental linking is performed based on service data newly added in a current incremental update period, to provide offline knowledge graph update and use an updated knowledge graph as an initial knowledge graph in a next round of incremental update.

This specification claims priority to Chinese Patent Application No. 202210290077.1, filed with the China National Intellectual Property Administration on Mar. 23, 2022 and entitled “METHOD AND APPARATUS FOR UPDATING KNOWLEDGE GRAPH”, which is incorporated herein by reference in its entirety.

### TECHNICAL FIELD

One or more embodiments of this specification relate to the field of computer technologies, and in particular, to a method and an apparatus for updating a knowledge graph.

### BACKGROUND

A knowledge graph is a semantic network that describes entities and relationships between the entities in the real world in a graph mode. By combining the knowledge graph with expert experience and prior data, correctness of relationships and rules in the graph can be explained, and relationships and rules that do not appear in the graph can be inferred. Service processing related to an association relationship of an entity can be performed by using the knowledge graph. In recent years, a knowledge graph platform has emerged as a middle platform with a knowledge graph as a core capability, and provides knowledge management, knowledge inference, and knowledge service capabilities for various services, and graph solutions matching these capabilities.

### SUMMARY

One or more embodiments of this specification describe a method and an apparatus for updating a knowledge graph, to resolve one or more problems mentioned in the background.

According to a first aspect, a method for updating a knowledge graph is provided. The method includes performing a plurality of rounds of incremental update on a knowledge graph, where one round of incremental update includes: obtaining an initial knowledge graph in the round of incremental update; and performing an update step that includes a repeatedly performed real-time update operation and an incremental update operation in a case in which a preset incremental update condition is met, where the real-time update operation includes: updating, in response to receiving new service data, an updated knowledge graph in a previous real-time update operation by using the received service data, and the incremental update operation includes: updating the initial knowledge graph by using service data generated during the round of incremental update, to use an updated knowledge graph as an initial knowledge graph in a next round of incremental update.

In an embodiment, the real-time update operation and the incremental update operation each include the following entity linking process: determining whether there are at least two nodes that correspond to service subjects that have the same characteristic; and when there are at least two nodes that correspond to service subjects that have the same characteristic, the following entity normalization process is further performed for an entity linking result: combining nodes that have the same characteristic into one node, and superposing corresponding entity description information of the nodes that have the same characteristic as entity description information of the combined node.

In an embodiment, when the round of incremental update is a first round of incremental update, the initial knowledge graph in the round of incremental update is obtained by performing entity normalization based on an entity linking result of a knowledge graph constructed by using full service data; or when the round of incremental update is not a first round of incremental update, the initial knowledge graph in the round of incremental update is obtained by performing entity normalization based on an incremental entity linking result of an initial knowledge graph in a previous round of incremental update.

In an embodiment, the full entity linking result of the knowledge graph constructed by using full service data is obtained in the following manner: for nodes in the knowledge graph constructed by using full service data, separately obtaining entity description information corresponding to the nodes; extracting feature vectors respectively corresponding to the nodes based on the entity description information respectively corresponding to the nodes; detecting a similarity between pairwise feature vectors; and identifying, based on whether the similarity between the pairwise feature vectors meets a predetermined homogeneity condition, whether corresponding pairwise nodes have the same characteristic.

In an embodiment, the initial knowledge graph includes a first node, first service data for the first node is currently received new service data, and updating, in response to generating new service data in a current service, an updated knowledge graph in a previous real-time update operation by using the received service data includes: updating first entity description information of the first node by using the first service data; extracting a first feature vector from updated first entity description information; comparing similarities that are in a one-to-one correspondence and that are between the first feature vector and other feature vectors of other nodes; obtaining, based on whether the similarities meet a predetermined homogeneity condition, a real-time entity linking result indicating whether there is another node that has the same characteristic as the first node; and updating the updated knowledge graph in the previous real-time update operation based on the real-time entity linking result.

In an embodiment, the method further includes adding currently received new service data to a current incremental dataset as incremental data; and updating the initial knowledge graph by using service data generated during the round of incremental update includes: performing incremental entity linking on the initial knowledge graph in the round of incremental update by using each piece of incremental data in the current incremental dataset; and updating the initial knowledge graph by using an incremental entity linking result.

In an embodiment, the incremental update condition includes: a predetermined period arrives or a quantity of pieces of service data generated during the round of incremental update reaches a predetermined quantity.

In an embodiment, when the round of incremental update is not a first round of incremental update, the update step further includes: obtaining each real-time update result obtained based on a real-time update operation performed after the preset incremental update condition is met in a previous round of incremental update; and updating the initial knowledge graph in the round of incremental update based on each real-time update result.

In an embodiment, the entity description information includes at least one of attribute information and connection information.

In an embodiment, the feature vector includes one of the following or a vector obtained by performing embedding on a plurality of items in the following: a text semantic vector, a trajectory vector, a graph structure vector, and a graph representation vector.

In an embodiment, a real-time entity linking process is completed by using an online search engine, and updating a current knowledge graph based on real-time entity linking is completed by using an online graph storage engine; and updating the initial knowledge graph by using an incremental entity linking result includes: synchronizing the incremental entity linking result to the online search engine and the online graph storage engine by using a data dump mechanism, to replace each real-time entity linking result generated during the round of incremental update with the incremental entity linking result, so as to update the initial knowledge graph by using the incremental entity linking result.

In an embodiment, when a second service subject involved in incremental data does not have a corresponding node in the initial knowledge graph in the round of incremental update, the incremental update operation further includes: adding a second node corresponding to the second service subject to the initial knowledge graph in the round of incremental update; and performing incremental entity linking based on a knowledge graph obtained after the second node is added.

In an embodiment, when the round of incremental update is a first round of incremental update, a first real-time update operation in the round of incremental update is updating the initial knowledge graph in the round of incremental update by using the received service data.

According to a second aspect, an apparatus for updating a knowledge graph is provided. The apparatus includes:
an obtaining unit, configured to obtain an initial knowledge graph in each round of incremental update; and
an update unit, configured to perform, in each round of incremental update, an update step that includes a repeatedly performed real-time update operation and an incremental update operation in a case in which a preset incremental update condition is met, where the real-time update operation includes: updating, in response to receiving new service data, an updated knowledge graph in a previous real-time update operation by using the received service data, and the incremental update operation includes: updating the initial knowledge graph by using service data generated during the round of incremental update, to use an updated knowledge graph as an initial knowledge graph in a next round of incremental update.

According to a third aspect, a computer-readable storage medium is provided. The computer-readable storage medium stores a computer program, and when the computer program is executed in a computer, the computer is enabled to perform the method according to the first aspect.

According to a fourth aspect, a computing device is provided, and includes a memory and a processor. The memory stores executable code, and when the processor executes the executable code, the method according to the first aspect is implemented.

According to the method and the apparatus provided in the embodiments of this specification, in a process of providing knowledge graph-based data support for a current service, a knowledge graph is updated by combining online and offline manners. First, full entity linking can be performed based on an initial knowledge graph constructed offline by using full service data, to initialize the knowledge graph as a cold-started knowledge graph. Then, a plurality of rounds of incremental update are performed on the cold-started knowledge graph. During a single round of incremental update, online real-time knowledge graph update is provided based on service data generated in real time; and when the preset incremental update condition is met, offline knowledge graph incremental entity linking is provided based on service data newly added during the current round of incremental update, and an offline incremental entity linking result is used to replace a real-time entity linking result to update the initial knowledge graph in the current round of incremental update. In this way, rounds of incremental update are repeated, to ensure, through online real-time entity linking, that knowledge graph data is updated in real time, and ensure accuracy of data non-omission through offline incremental entity linking, so that a related service processing result based on a corresponding knowledge graph is more accurate and effective.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating a specific implementation scenario according to this specification;

FIG. 2 is a schematic diagram illustrating a specific implementation architecture for updating a knowledge graph according to this specification;

FIG. 3 is a flowchart illustrating a full entity linking method for an initial knowledge graph according to an embodiment of this specification;

FIG. 4 is a flowchart illustrating a method for updating a knowledge graph according to an embodiment of this specification; and

FIG. 5 is a schematic block diagram illustrating an apparatus for updating a knowledge graph according to an embodiment.

### DESCRIPTION OF EMBODIMENTS

The technical solutions provided in this specification are described below with reference to the accompanying drawings.

To understand the technical solutions in this specification more clearly, the technical background provided in the technical solutions in this specification is first described with reference to a specific implementation scenario.

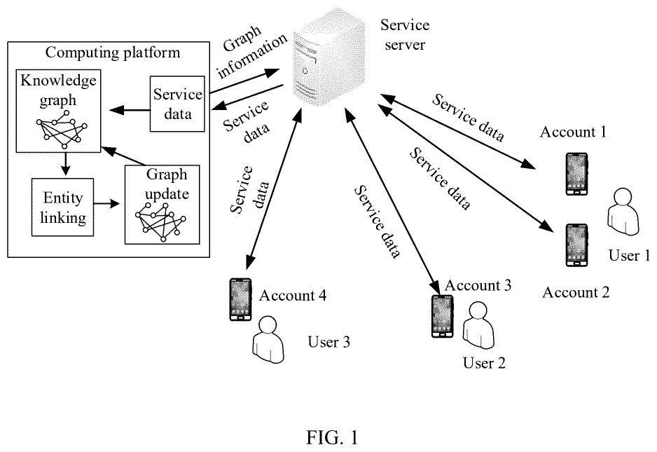

FIG. 1 shows a specific implementation architecture of this specification. The implementation architecture relates to a scenario in which service processing is performed based on a knowledge graph. In the implementation architecture shown in FIG. 1, a service server can provide corresponding service support for a related service (for example, a search service, a query service, a collection/payment service, or a navigation service) executed by each user on a corresponding terminal. A computing platform can exchange data with the service server. The computing platform can be another computer, device, server, or the like that is connected to the service server, can be a part of the service server, or is disposed in the service server. This is not limited herein. In a specific example, the computing platform can be a knowledge graph service platform that is used as a middle platform with a knowledge graph service as a core capability and that provides knowledge management, knowledge inference, and knowledge service function support for various services, and graph solutions matching these functions.

A single service subject can execute a related service by using an account registered with the service server in advance. The single service subject can be an independent entity that executes a predetermined service, for example, a natural person, a merchant, or an enterprise. The account is described, for example, by using a unique user identifier (for example, a mobile phone number or a bank card number). In practice, one service subject (actual user or controller of an account) may register one or more user identifiers. As shown in FIG. 1, as a service subject, a user 1 registers an account 1 and an account 2, a user 2 registers an account 3, and a user 3 registers an account 4.

If a related service is executed based on a knowledge graph, the knowledge graph can be constructed by collecting service data corresponding to each user identifier. In an initially constructed knowledge graph, a single user identifier can be used as a service subject to correspond to a single node. Based on the above-mentioned case in which one service subject registers a plurality of accounts, a full entity linking operation can be further performed based on feature data of each node, and entity normalization can be performed on nodes with different user identifiers controlled by the same service entity, to update a corresponding knowledge graph and store the knowledge graph on the computing platform for use by the service server.

Further, the service server can obtain related data in the knowledge graph from the computing platform for service processing. Service data generated in a service processing process can be transferred to the computing platform. To better provide data services for real-time services, the knowledge graph needs to be continuously updated. Therefore, the computing platform can perform an entity linking operation on the knowledge graph based on the service data, to correct an entity normalization result in the knowledge graph based on new service data, so as to update the knowledge graph.

Through entity linking, it can be inferred, from a perspective of service application, whether service subjects corresponding to any two nodes in the knowledge graph have the same characteristic. The same characteristic usually indicates the same corresponding service subject. For example, it indicates whether two users belong to the same family, whether two collection codes belong to the same store, and whether two accounts belong to the same natural person. The same family, the same store, and the same natural person herein each represent a service subject. When the two users, the two collection codes, and the two accounts have the same characteristic, the two users, the two collection codes, and the two accounts can correspond to the same service subject. An objective of entity linking is usually entity normalization, that is, based on an entity linking result, a plurality of service subjects (nodes) “identified as having the same characteristic” are further processed in a combination processing manner of entity description information (for example, attribute information and connection relationship information), to obtain a unique service subject (node). Description information (for example, a connection relationship and attribute information) on a plurality of nodes corresponding to service subjects “identified as having the same characteristic” before normalization is mounted to a service subject (that is, a node) obtained after normalization.

Based on entity linking and an entity normalization operation, knowledge fusion can be performed for the knowledge graph. In a conventional technology, update of knowledge fusion for the knowledge graph is usually performed through offline batch processing or online real-time processing. Offline batch update is performed, for example, based on a predetermined period (for example, one day), and there is a problem of poor timeliness. For online real-time processing, due to a network problem, an incomplete data problem, and the like, there is a possibility that fusion fails. For example, when message congestion occurs, if a fusion target (a node that needs to be fused) is not recorded into the knowledge graph, the fusion target cannot be linked. Reduced availability of the knowledge graph and reduced service processing accuracy are caused due to long-term accumulation.

In view of this, this specification provides improvements to a knowledge graph update process, to obtain knowledge graph data with higher availability, so as to improve accuracy and effectiveness of corresponding service processing. In the implementation scenario shown in FIG. 1, entity linking and an entity normalization operation are performed on the knowledge graph to improve a part of the knowledge graph by using updated service data. Therefore, this specification provides a knowledge graph update solution in which offline and online manners are combined.

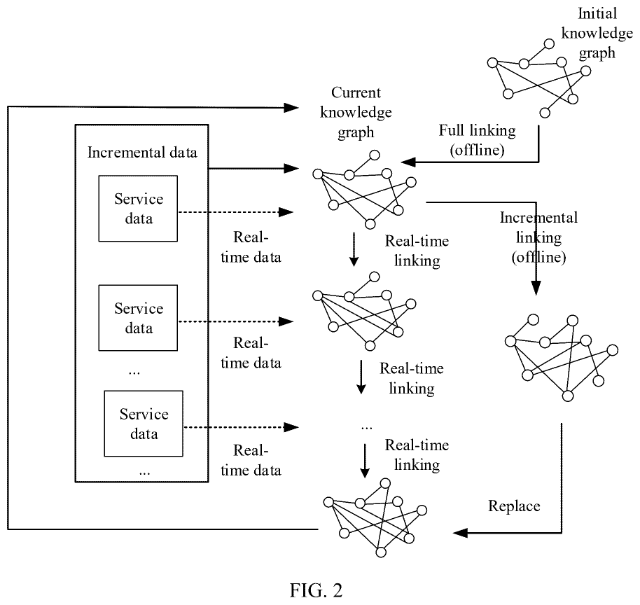

FIG. 2 shows a technical architecture of this specification. As shown in FIG. 2, in an implementation architecture of this specification, a knowledge graph fusion process can include three entity linking processes: full entity linking, real-time entity linking, and incremental entity linking. An objective of entity linking is to fuse knowledge in a knowledge graph. Therefore, when there are at least two nodes that correspond to service entities that have the same characteristic in an entity linking result, it can be determined that service entities corresponding to nodes that have the same characteristic are the same service entity, to perform an entity normalization operation. Otherwise, if there are no any two nodes that correspond to service entities that have the same characteristic in the entity linking result, the entity normalization operation is not performed. That is, the entity normalization operation is performed or not performed based on the entity linking result. Therefore, in FIG. 2, only a schematic diagram of entity linking is indicated, and the entity normalization operation is not marked. For ease of description, in FIG. 2, full entity linking, real-time entity linking, and incremental entity linking are respectively referred to as full linking, real-time linking, and incremental linking.

Full linking is usually performed on all data in the knowledge graph, and can be considered as an initialization process of the current knowledge graph. Full data usually has a relatively large data magnitude, for example, 10 trillion pieces of data. Therefore, full linking is usually performed once before a data service is provided by using the knowledge graph. However, it is not excluded that in an optional implementation, full linking is performed based on a predetermined full linking condition. For example, a full linking operation is performed every half a year or one year. The full linking operation is usually an operation performed offline.

Both real-time linking and incremental linking can be considered as linking operations on incremental data. Usually, real-time linking has a relatively small data magnitude, and is usually performed on an added single piece of service data. Incremental linking has a data magnitude that is far greater than the data magnitude of real-time linking but is less than a data volume of full linking, for example, is performed on 100000 pieces of service data. As shown in FIG. 2, after the offline full linking operation is performed on an initial knowledge graph, a knowledge graph obtained after entity normalization can be used as an initialized current knowledge graph to perform related service processing as an online database. In a service processing process, new service data may be continuously generated. For example, if a specific service is a transfer service from Amy to Lily, a node attribute or a connection attribute in a knowledge graph corresponding to Amy and Lily changes, for example, changes from no connection to a connection. For such real-time service data, a feature change of Amy and Lily can be monitored in real time, and a changed feature is compared with another node, to explore whether two nodes respectively corresponding to Amy and Lily after the change become similar to a feature of the other node. The process is a real-time linking process. It can be learned from the above-mentioned example that real-time linking is an online process, and an entity normalization operation can be performed or an entity normalization operation may not be performed based on a real-time linking result. As shown in FIG. 2, the knowledge graph can be continuously updated based on the real-time linking result in a service data update process. Such update can include update of entity description information corresponding to a node, update of a feature vector of a node, or the like.

Incremental linking can be performed based on a predetermined incremental update condition, for example, is performed at a fixed time (for example, 0:00) every day, or is performed based on a volume of generated service data (for example, every 100000 pieces of data). Each time the incremental update condition is met, one round of incremental update can be performed. The incremental data is usually accumulated data of a plurality of pieces of real-time service data. After the incremental linking operation is completed, an update result based on real-time linking for the knowledge graph during a current round of incremental update can be replaced. For example, the current knowledge graph is denoted as T, real-time linking for various pieces of service data is respectively denoted as δ₁, δ₂, . . . , δₜ, and the like, and a knowledge graph obtained after a t^{th} time of real-time update is denoted as T+δ₁+δ₂ . . . +δₜ. In this case, incremental linking is performed. If the incremental data is denoted as t, the incremental linking result can be denoted as Δₜ, and a knowledge graph obtained by performing update by using the incremental linking result is denoted, for example, as T+Δ₁. In this case, it is equivalent to replacing δ₁+δ₂ . . . +δₜ with Δₜ. The knowledge graph obtained after incremental update can be used as an initial knowledge graph in a next round of incremental update. Incremental linking can be an offline entity linking process.

In this way, the current knowledge graph is initialized by using the offline full linking result, and online real-time linking update and offline incremental linking update in subsequent incremental update rounds are performed, so that both real-time performance and data accuracy are considered for the current knowledge graph, to maintain high availability of the knowledge graph.

The following describes the technical concept of this specification in detail.

First, it should be noted that the knowledge graph involved in this specification can be a knowledge graph in any service scenario, for example, a merchant graph that describes a relationship between merchants/enterprises, where each node in the knowledge graph corresponds to each merchant/enterprise, and two nodes corresponding to two merchants/enterprises that have an association relationship are connected by using a connecting edge; or a knowledge graph that describes consumer preferences, where each node can correspond to a merchant, a consumer, a commodity, or the like, and merchants consumed by consumers and two corresponding nodes are connected by using a connecting edge, and similarly, commodities purchased by consumers, commodities operated by merchants, and corresponding nodes can be connected by a connecting edge to express a connection relationship between the commodities purchased by consumers, the commodities operated by merchants, and the corresponding nodes.

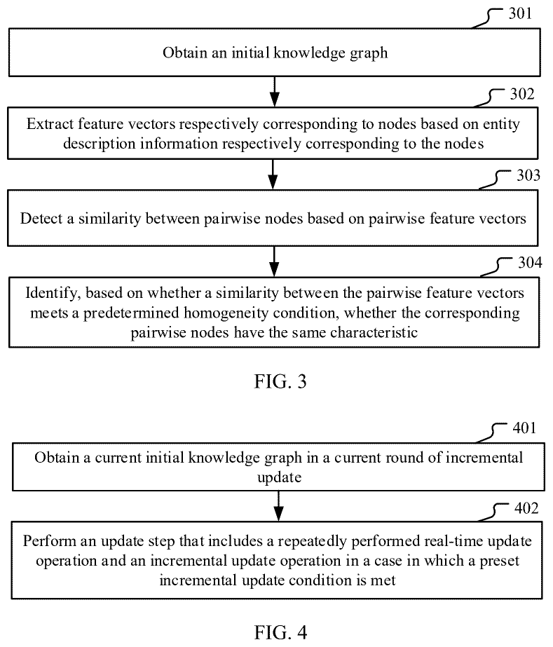

FIG. 3 shows a full entity linking procedure for a knowledge graph according to an embodiment of this specification. The procedure can be performed by a computer, a device, or a server that has a specific computing capability, and more specifically, for example, can be performed by the computing platform in FIG. 1. The full entity linking procedure for a knowledge graph shown in FIG. 3 can be used for initial knowledge fusion for full service data. This procedure can be performed only once in a knowledge graph update process, or in some possible embodiments, can be performed once every a relatively long time interval, for example, half a year, one year, or five years.

As shown in FIG. 3, the full entity linking procedure for a knowledge graph can include: Step 301: For nodes in a knowledge graph constructed by using full service data, separately obtain entity description information corresponding to the nodes, where the knowledge graph includes nodes that are in a one-to-one correspondence with service subjects in the full service data, and a connecting edge that connects pairwise nodes, to describe a connection relationship between service subjects. Step 302: Extract feature vectors respectively corresponding to the nodes based on the entity description information respectively corresponding to the nodes. Step 303: Detect a similarity between pairwise nodes based on the feature vectors. Step 304: Identify, based on whether a similarity between pairwise feature vectors meets a predetermined homogeneity condition, whether corresponding pairwise nodes have the same characteristic.

First, in step 301, for the nodes in the knowledge graph constructed by using full service data, the entity description information corresponding to the nodes is separately obtained.

The knowledge graph herein can be a knowledge graph constructed based on initial full service data, for example, a knowledge graph constructed based on merchant data such as a collection account of an offline merchant. The initial knowledge graph can include nodes that are in a one-to-one correspondence with service subjects, and a connecting edge that connects pairwise nodes, to describe a connection relationship between service subjects. It is assumed that in a merchant graph, a single collection account corresponds to one node in the knowledge graph as a service subject. If there is an association relationship between two collection accounts, two corresponding nodes are connected by using a connecting line. The association relationship herein can include, for example, but is not limited to a transfer, consistent registrant identity information (for example, a name or a telephone number), mutual following, being friends in address books of each other, and the like.

Service data for constructing the initial knowledge graph can be obtained in various manners such as online capture and offline statistics collection. The initial knowledge graph can be constructed in advance based on the full service data, or can be constructed in a current procedure based on the full service data. This is not limited herein.

It can be understood that the entity description information corresponding to the node is used to describe a service subject corresponding to the node. The entity description information can include at least one of attribute information of the service subject and connection information that is of the service subject and that is associated with another service subject. The attribute information can be information describing various attributes of a corresponding single service subject (for example, a single collection account). For example, attribute information of a service subject corresponding to a merchant can include at least one of the following: a registration time, a registration location, a bound bank card, a transaction device, a login mobile number, and the like. A connection relationship with another node describes an association relationship between entities corresponding to nodes.

Then, in step 302, the feature vectors respectively corresponding to the nodes are extracted based on the entity description information respectively corresponding to the nodes.

A process of extracting the feature vector from the entity description information of the node is a process of digitizing the entity description information. That is, the entity information is represented by using abstract data, to help a computer process the information. A corresponding feature vector can be extracted based on entity description information corresponding to a single node. In the embodiments of this specification, the feature vector of the node can include at least one of a text semantic vector, a location-based service (LBS) vector, a graph structure vector, a graph representation vector, and the like, and is used to describe a corresponding service entity.

The text semantic vector can be semantic information extracted from information that describes a corresponding service subject by using text, for example, an operating scope of a merchant. The semantic vector can be a fused vector of word vectors respectively corresponding to words obtained after word segmentation, for example, a vector obtained by fusing the word vectors in a manner of splicing or embedding.

The LBS vector can represent location-based trajectory information. Specifically, location information of a corresponding service subject can be collected in a time sequence, to construct a trajectory vector of the service subject. For example, a predetermined quantity (for example, five) of location points are sampled forward, or location points within a predetermined time period (for example, 24 hours before a sampling time) are sampled, and are sequentially arranged to form a trajectory vector. In an example, if five latest location points that a merchant sequentially passes through are L1, L7, L6, L5, and L3, there can be a corresponding location vector (L1, L7, L6, L5, L3). A collection manner of the location point is related to the service subject. When the service subject corresponds to a terminal device having a communication function, a corresponding location point can be collected by using the corresponding terminal device. When the service subject can correspond to another carrier (for example, a paper two-dimensional code) that is not related to an electronic device, a corresponding location point can be collected by using another terminal device that uses the carrier. Details are not described herein.

The graph structure vector can be used to describe a connection relationship between a single node and another node. For example, for a single node in the knowledge graph, a single graph structure vector is constructed based on each connected path involved by the single node in the knowledge graph, a vector including one row or one column of elements corresponding to the single node in an adjacency matrix of the knowledge graph is used as the graph structure vector, or the like.

The graph representation vector can be a representation vector obtained by processing a knowledge graph by using a graph model. In this case, a graph representation vector of a single node can incorporate a feature of the single node and a feature of a neighboring node of the single node, and therefore includes both attribute information of a corresponding service subject and connection information between the corresponding service subject and another service subject.

In another embodiment, based on the entity description information corresponding to the node, another description vector can be further extracted. Examples are not listed one by one herein. A corresponding service subject can be described from one or more dimensions by using one or more of these description vectors. When there is one description vector for a single service subject, the corresponding one description vector can be used as a feature vector of a corresponding single node. When there are a plurality of description vectors for a single service subject, a splicing vector or an embedding vector of the plurality of description vectors can be used as a feature vector of a corresponding single node. The embedding vector can be obtained through neural network processing, can be obtained by weighting or averaging the description vectors, or the like. This is not limited herein.

In this way, a feature vector of each node can be obtained. The feature vector describes various types of information about a service subject corresponding to a node. To detect whether pairwise service subjects have the same characteristic, step 303 can be performed to detect a similarity between pairwise nodes based on pairwise feature vectors.

In an embodiment, a similarity between two vectors can be measured by using a matching degree between the vectors. The matching degree can be determined, for example, based on a quantity of elements that consistently match and a total quantity of elements. For example, when dimensions of the two feature vectors are consistent, the matching degree between the two feature vectors can be determined based on a ratio of the quantity of elements that consistently match to a quantity of vector dimensions. For example, in a specific example, if each of the two feature vectors has 10 dimensions, and eight elements consistently match, it can be determined that the matching degree between the two feature vectors is 80%. When the two feature vectors are inconsistent, the matching degree between the two feature vectors can be determined based on a ratio of the quantity of elements that consistently match to a pre-agreed larger or smaller quantity of vector dimensions. For example, if the two feature vectors respectively have 10 dimensions and eight dimensions, eight elements consistently match, and comparison with a smaller vector dimension is performed, it can be determined that the matching degree between the two feature vectors is 100%.

In another embodiment, a similarity between two vectors can be measured by using a similarity degree between the vectors. The similarity degree between the vectors can be measured, for example, by using parameters such as a Jaccard coefficient, a cosine similarity degree, a Pearson similarity degree, a Euclidean distance, and KL divergence (Kullback-Leibler divergence, relative entropy). The similarity degree between the two vectors can be positively correlated with one of the Jaccard coefficient, the cosine similarity degree, the Pearson similarity degree, and the like, or negatively correlated with one of the Euclidean distance, the KL divergence, and the like.

The Jaccard coefficient is used as an example. In this case, a similarity degree between two vectors A and B can be described, for example, as

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} .$$

Herein, |̅A̅∩̅B̅|̅ represents a quantity of same elements in the two vectors A and B, and |A∪B| represents a total quantity of elements in the two vectors A and B after the same elements are combined.

It should be noted that a calculation manner of the Jaccard coefficient does not require that quantities of dimensions of the two vectors A and B are necessarily equal, and therefore has higher universality. However, methods such as the cosine similarity degree, the Pearson similarity degree, the Euclidean distance, and the KL divergence are usually more applicable to measuring a similarity between sets with same elements (for example, vectors with the same quantity of dimensions).

In step 304, it is identified, based on whether a similarity between the pairwise feature vectors meets a predetermined homogeneity condition, whether the corresponding pairwise nodes have the same characteristic.

It can be understood that an objective of detecting the similarity between pairwise nodes is to perform entity linking, that is, to determine whether the two nodes have the same characteristic (corresponding to the same service subject). The determining condition can be preset, and is denoted as the predetermined homogeneity condition herein. Based on different measurement manners of a vector similarity, the predetermined homogeneity condition can be that a vector matching degree exceeds a predetermined matching degree threshold, a vector similarity degree exceeds a predetermined similarity degree threshold, or the like.

It should be noted that when a single feature vector and at least two feature vectors meet the predetermined homogeneity condition, the other at least two feature vectors do not necessarily meet the predetermined homogeneity condition pairwise. In this case, when a similarity between two feature vectors meets the predetermined homogeneity condition, it is considered that service subjects corresponding to two corresponding nodes are the same. In this way, when a single feature vector and at least two feature vectors meet the predetermined homogeneity condition, it can be determined that these nodes have the same characteristic and correspond to the same service subject. In an example, it is assumed that a feature vector Ia corresponding to a node a and a feature vector Ib corresponding to a node b meet the predetermined condition, and the feature vector Ib corresponding to the node b and a feature vector Ic corresponding to a node c meet the predetermined homogeneity condition. In this case, because it can be obtained that the node a and the node b correspond to the same service subject, and the node b and the node c correspond to the same service subject, regardless of whether the feature vector Ia corresponding to the node a and the feature vector Ic corresponding to the node c meet the predetermined homogeneity condition, it can be determined that the nodes a, b, and c correspond to the same service subject, for example, correspond to the same merchant or the same consumer.

Further, entity normalization can be performed on nodes corresponding to the same service subject in the initially constructed knowledge graph. That is, the nodes are combined into one node, and corresponding entity description information (for example, information such as attribute information and connection information) is fused. For example, in the above-mentioned example, the nodes a, b, and c are combined into a node a′, and attribute information and connection information of the nodes a, b, and c belong to the node a′. For example, if the node a is connected to nodes e and d, the node b is connected to nodes d and h, and the node c is connected to a node g, the node a′ obtained after the combination has a connection relationship with all of the nodes e, d, h, and g.

In an optional embodiment, a process of normalizing entity description information such as attribute information and connection information of nodes corresponding to the same service subject can be implemented by fusing feature vectors. For example, feature vectors of a plurality of corresponding nodes (for example, the nodes a, b, and c) are fused in one of manners such as averaging, adding, calculating a median of, and embedding feature vectors of the nodes corresponding to the same service subject, and a fused feature vector is used as a feature vector for describing service entity information corresponding to a node obtained after normalization.

In this way, each group of nodes corresponding to the same service subject in the initially constructed knowledge graph can be separately combined and normalized to form an initial full knowledge graph.

The initial full fusion knowledge graph can be used as an initial knowledge graph in an initial incremental update round to provide a graph service for an online service, and is cyclically updated. As described above, cyclic update is performed by combining an offline incremental update cycle and an online real-time update cycle shown in FIG. 2. FIG. 4 shows a procedure of updating a knowledge graph in a process of providing a graph service for an online service by using the knowledge graph. The procedure is performed by any computer, device, or server that can exchange data in real time with a service server and that has a computing capability, for example, the computing platform in FIG. 1. Further, the execution body of the procedure can be consistent or can be inconsistent with the execution body of the procedure shown in FIG. 3. It can be understood that after the knowledge graph is online, an entity linking process of the knowledge graph can be performed based on an incremental update round. For ease of description, an implementation procedure shown in FIG. 4 is described by using one incremental update round as an example.

As shown in FIG. 4, in the procedure of updating a knowledge graph according to an embodiment of this specification, one round of incremental update can include: Step 401: Obtain an initial knowledge graph in the round of incremental update. Step 402: Perform an update step that includes a repeatedly performed real-time update operation and an incremental update operation in a case in which a preset incremental update condition is met, where the real-time update operation includes: updating, in response to receiving new service data, an updated knowledge graph in a previous real-time update operation by using the received service data, and the incremental update operation includes: updating the initial knowledge graph in the round of incremental update by using service data generated during the round of incremental update, to use an updated knowledge graph as an initial knowledge graph in a next round of incremental update.

First, step 401 is performed to obtain the initial knowledge graph in the round of incremental update.

The initial knowledge graph in the current round of incremental update is an initial knowledge graph in a current incremental update round. The initial knowledge graph can be determined based on a full linking result of a knowledge graph that is initially constructed by using full service data. Specifically, during a first round of incremental update, the initial knowledge graph can be a knowledge graph obtained by performing full data entity linking update by using the entity linking procedure shown in FIG. 3; and during a non-first round of incremental update, the initial knowledge graph can be a knowledge graph obtained after several rounds of incremental update are performed based on a knowledge graph obtained by performing full linking update by using the entity linking procedure shown in FIG. 3, that is, is a knowledge graph obtained after a previous round of incremental update.

The initial knowledge graph can be used to provide data support of the knowledge graph for a current service. For example, in a current service processing process, at least one of attribute data or association relationship data of a service subject can be obtained from a current knowledge graph. The current service can be various services related to the current knowledge graph. For example, when the current knowledge graph is a merchant graph, each node corresponds to each collection account, and the current service can be a rights and interests incentive service. If a single merchant completes 50 collections within 24 hours, the single merchant is immediately rewarded with predetermined points, red envelopes, cash, or the like. In this way, in the current service, when a merchant executes a collection service, attribute data or the like related to a quantity of collections can be obtained from the knowledge graph.

Then, in step 402, the update step is performed.

According to the technical concept of this specification, the update step is an update step based on the above-mentioned initial knowledge graph. The update step can include the repeatedly performed real-time update operation and the incremental update operation in the case in which the preset incremental update condition is met.

It can be understood that new service data can be generated in a process of executing the current service. For example, when a rights and interests incentive service is executed by using the merchant graph, service data such as a collection amount, a payer, a payment time, and a collection location can be generated for a payee in a collection service. The new service data may affect attribute information and the like of a node in the knowledge graph. For example, a quantity of collections increases, a collection trajectory changes, an association relationship changes, and even a quantity of nodes may increase (for example, new registered accounts appear). To meet a real-time service requirement, a real-time entity linking operation can be performed on the newly generated service data.

It can be understood that the real-time entity linking operation is performed on real-time service data in a service processing process, and is entity linking locally performed on the knowledge graph. More specifically, the real-time entity linking operation is performed on a node involved in current service data. For example, the current service includes a first service, and for a first node involved in first service data generated by the first service, corresponding entity description information of the first node is modified based on the first service data. Then, for the first node, a feature vector corresponding to the first node is extracted based on modified entity description information, for example, is denoted as a first feature vector. Then, similarity comparison is performed between the first feature vector and other feature vectors respectively corresponding to other nodes, to determine whether there is another node that has the same characteristic as the first node after information update, so as to complete real-time entity linking.

Further, based on the new service data generated in real time, when the involved node is identified as having the same characteristic as several other nodes, these nodes can correspond to the same service subject. In this case, nodes corresponding to the same service subject can be combined and normalized (entity normalization is performed). For example, if it is detected that the first node has the same characteristic as a second node and a third node, it can be considered that the first node, the second node, and the third node correspond to the same service subject. In this case, the first node, the second node, and the third node can be combined into one node (for example, the first node), and entity description information of the three nodes can be combined into entity description information corresponding to the combined node (for example, the first node). In addition, when the involved node is identified as having the same characteristic as none of several other nodes, the real-time entity linking result is recorded, entity description information after the first service data is fused for the first node, and no entity normalization operation needs to be performed.

In this way, the current knowledge graph can be updated in real time, and subsequent service processing can be performed by using an updated knowledge graph. In addition, when new service data is continuously generated, real-time entity linking results can be superposed. The real-time entity linking operation on the knowledge graph can be performed by using an online knowledge graph-based search engine such as ha3, Probase, Zhixin, and Zhi lifang. In a search process, the online search engine can associate knowledge in the knowledge graph, feed back a more accurate search result to a user, and collect a service processing result, for example, whether the user selects information that is fed back. In addition, entity normalization can be completed, for example, by using an online graph storage engine such as GeaBase and gStore. For example, node identifiers of nodes that have the same characteristic are modified to be consistent, and entity description information corresponding to each node is stored in a correspondence with a modified node identifier.

In addition, the service data generated in real time may not be completely updated in a timely manner by using the real-time entity linking operation. For example, in a service process, two involved service subjects are, for example, an account A and an account B, and service content is that the account A makes a transfer service to the account B. Only one (for example, the account B) of the two service subjects corresponds to a corresponding node (for example, a node b) in the current knowledge graph, and the other node does not correspond to a corresponding node in the current knowledge graph. In this case, for a service subject that does not correspond to a corresponding node, data of the service subject cannot be added to the current knowledge graph in real time. Therefore, related data can be missed by using only real-time entity linking.

Therefore, the service data generated by the current service can be further recorded into a current incremental dataset as incremental data. The current incremental dataset herein can be a dataset used to record incremental data in the current round of incremental update. The incremental dataset can be a dataset having a predetermined identifier, for example, an identifier (for example, t) corresponding to a current incremental update period, or can be stored based on a predetermined incremental storage location. This is not limited herein.

The incremental update condition can be a trigger condition for performing incremental update on the knowledge graph, and can be preset based on a specific service. In an embodiment, the incremental update condition can be that a predetermined time interval passes or a predetermined period arrives. For example, if the predetermined time interval is 24 hours, the incremental update condition is met every 24 hours. In another embodiment, the incremental update condition is that a quantity of pieces of accumulated service data reaches a predetermined quantity, for example, 100000. In this case, each time 100000 pieces of incremental data are added to the incremental dataset, the incremental update condition is met.

When the incremental update condition is met, incremental entity linking can be performed by using the incremental data. An incremental entity linking manner is similar to real-time entity linking, and a difference lies in that incremental entity linking is performed for a plurality of pieces of service data, involves more nodes, and can be performed in an offline manner. For example, in an incremental entity linking process, offline data in the incremental dataset can be obtained for an operation, and the process is separated from the current online service.

Specifically, the incremental entity linking process can be performed for several nodes related to each piece of incremental data. For example, description information change data or the like of a service subject included in the incremental data can be added to corresponding nodes (for example, 100 nodes), and feature vectors of these nodes can be re-extracted. Then, for a single node in these nodes, similarity comparison is performed between the re-extracted feature vector and a feature vector of another node, and nodes whose similarity meets a similarity condition are determined to have the same characteristic, and may correspond to the same service subject.

To ensure consistency of knowledge graph update, data update can be performed on the initial knowledge graph in the current round by using an incremental entity linking result, and an updated knowledge graph is used as the initial knowledge graph in the next round of incremental update.

Specifically, the real-time entity linking result during the round of incremental update can be replaced with the incremental entity linking result. Therefore, when there are pairwise service entities that have the same characteristic in the incremental entity linking result, entity normalization is performed by using the incremental entity linking result to form a new knowledge graph. The real-time linking result during the round of incremental update can be replaced with the incremental entity linking result by using a data dump (for example, dump) mechanism. Specifically, the incremental entity linking result is synchronized to the online search engine (for example, ha3) and the online graph storage engine (for example, GeaBase), to replace each real-time entity linking result generated during the current round of incremental with the incremental entity linking result.

It should be noted that there may be at least two nodes that have the same characteristic in the incremental entity linking result. In this case, an entity normalization operation can be performed based on the incremental entity linking result. In an optional embodiment, there may be no any two nodes that have the same characteristic in an incremental linking result of service data generated during one round of incremental update. In this case, an entity normalization operation of node combination does not need to be performed.

It can be understood that incremental entity linking usually needs to process service data that is far larger than that in a single time of real-time entity linking. Therefore, because a data volume of incremental entity linking is larger, a time consumed by incremental entity linking is often much greater than a time consumed by real-time entity linking, for example, 30 minutes or 1 hour. The time consumed cannot be ignored during the online service of the knowledge graph. That is, in an incremental entity linking process, service processing is still ongoing, new service data may still be generated, and real-time entity linking may continue to be performed.

Therefore, to ensure real-time performance of knowledge graph data, according to a possible design, after the initial knowledge graph is updated, several real-time entity linking results generated after the incremental update condition is met can be accumulated on the current initial knowledge graph. For example, if the incremental data for the current round of incremental update is γ₁ to γ_{T}, current incremental entity linking is performed for the incremental data γ₁ to γ_{T}. The incremental entity linking result is denoted, for example, as Δ_{T}, and the current knowledge graph T is updated to T+Δ_{T} based on the incremental entity linking result Δ_{T}. In the current incremental entity linking process, real-time service data γ_{T+1} to γ_{T+s} is generated. The current knowledge graph may continue to be updated in real time through real-time linking. For example, s times of real-time linking δₜ₊₁, δₜ₊₂, . . . , and δₜ₊ₛ are performed. In this case, to adapt to subsequent services, the current knowledge graph should logically have results of the s times of real-time linking. Real-time linking δₜ₊₁, δₜ₊₂, . . . , δₜ₊ₛ, and the like is equivalent to real-time linking performed after current incremental linking. Therefore, on the updated knowledge graph, s real-time linking results can be added to the current knowledge graph T+Δₜ to obtain a knowledge graph T+Δₜ+δₜ₊₁+δₜ₊₂ . . . +δₜ₊ₛ for subsequent service processing. That is, the knowledge graph T+Δₜ obtained after update is performed based on the incremental entity linking result can be used as the initial knowledge graph in the next round of incremental update. To ensure normal service processing, the above-mentioned s real-time linking results are added to the initial knowledge graph. The real-time service data γ_{T+1} to γ_{T+s} can be used as incremental data in a next incremental update period. During the next round of incremental update, if an incremental linking result is Δ₂₁, and can be used to replace all real-time linking data after the knowledge graph T+Δₜ, a knowledge graph T+Δₜ+Δ₂ₜ is obtained, and is used as an initial knowledge graph in a further next period.

Only for the current round of incremental update, if there is a previous round of incremental update period T−1, after the initial knowledge graph in the round of incremental update is obtained in step 401, the update step in step 402 can further include an operation of superposing real-time entity linking results (for example, δ₁ to δₘ) of real-time service data (for example, γ₁ to γₘ, where m is less than t) generated after the incremental update condition is met in the previous incremental update period T−1.

In an optional implementation, the real-time service data and the real-time entity linking result can be stored based on identifiers in a manner in which identifiers are added in a predetermined order, to identify service data, real-time entity linking result data, and the like existing before and after the incremental update condition is met. For example, a timestamp, a sequence number, or the like generated by a service is used as a version identifier.

In this way, a knowledge graph with higher availability can be obtained by using the cyclically updated knowledge graph and with reference to online real-time performance and offline accuracy, to provide support for a corresponding service, so as to obtain a more effective service result. For example, a merchant and a commodity are more effectively recommended to a user, and a natural person, a merchant, a different account of an enterprise, and the like are more effectively identified.

In the above-mentioned process, in a process of providing knowledge graph-based data support for a current service, a knowledge graph is updated by combining online and offline manners. First, the knowledge graph is constructed offline by using full service data, and full entity linking and entity normalization are performed to initialize the knowledge graph. Then, an incremental update condition is set to perform rounds of cyclic update on the knowledge graph. Real-time linking is performed based on service data generated in real time, to provide online knowledge graph update. In addition, when the preset incremental update condition is met, incremental entity linking is performed based on service data newly added during the current round of incremental update, to provide offline knowledge graph update. Then, an offline incremental entity linking result is fused with an online real-time entity linking result to update the current knowledge graph. In this way, incremental update rounds are repeated, to ensure, through online real-time entity linking, that knowledge graph data is updated in real time, and ensure accuracy of data non-omission through offline incremental entity linking, so as to improve data availability of the knowledge graph, so that a related service processing result is more accurate and effective.

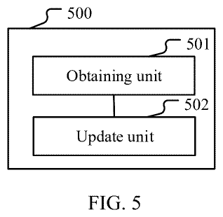

According to an embodiment in another aspect, an apparatus for updating a knowledge graph is further provided. FIG. 5 shows an apparatus 500 for updating a knowledge graph according to an embodiment. As shown in FIG. 5, the apparatus 500 can include:

an obtaining unit 501, configured to obtain an initial knowledge graph in each round of incremental update; and

an update unit 502, configured to perform, in each round of incremental update, an update step that includes a repeatedly performed real-time update operation and an incremental update operation in a case in which a preset incremental update condition is met, where the real-time update operation includes: updating, in response to receiving new service data, an updated knowledge graph in a previous real-time update operation by using the received service data, and the incremental update operation includes: updating the initial knowledge graph by using service data generated during the round of incremental update, to use an updated knowledge graph as an initial knowledge graph in a next round of incremental update.

When the round of incremental update is a first round of incremental update, the initial knowledge graph in the round of incremental update is obtained by performing entity normalization based on an entity linking result of a knowledge graph constructed by using full service data; or when the round of incremental update is not a first round of incremental update, the initial knowledge graph in the round of incremental update is obtained by performing entity normalization based on an incremental entity linking result of an initial knowledge graph in a previous round of incremental update.

In an embodiment, the real-time update operation and the incremental update operation each include the following entity linking process: determining whether there are at least two nodes that correspond to service subjects that have the same characteristic; and

when there are at least two nodes that correspond to service subjects that have the same characteristic, the following entity normalization process is further performed for an entity linking result: combining nodes that have the same characteristic into one node, and superposing corresponding entity description information of the nodes that have the same characteristic as entity description information of the combined node.

In an embodiment, the apparatus 500 can further include an initialization unit (not shown), configured to determine, in the following manner, the full entity linking result of the knowledge graph constructed by using full service data:
for nodes in the knowledge graph constructed by using full service data, separately obtaining entity description information corresponding to the nodes;
extracting feature vectors respectively corresponding to the nodes based on the entity description information respectively corresponding to the nodes;
detecting a similarity between pairwise nodes based on pairwise feature vectors; and
identifying, based on whether a similarity between the pairwise feature vectors meets a predetermined homogeneity condition, whether the corresponding pairwise nodes have the same characteristic.

In an optional implementation, the initial knowledge graph includes a first node, first service data for the first node is currently received new service data, and updating, in response to generating new service data in a current service, an updated knowledge graph in a previous real-time update operation by using the received service data includes:
updating first entity description information of the first node by using the first service data;
extracting a first feature vector from updated first entity description information;
comparing similarities that are in a one-to-one correspondence and that are between the first feature vector and other feature vectors of other nodes;
obtaining, based on whether the similarities meet a predetermined homogeneity condition, a real-time entity linking result indicating whether there is another node that has the same characteristic as the first node; and
updating the updated knowledge graph in the previous real-time update operation based on the real-time entity linking result.

According to a possible design, the update unit 502 is further configured to:
add currently received new service data to a current incremental dataset as incremental data; and
updating the initial knowledge graph by using service data generated during the round of incremental update includes:
performing incremental entity linking on the initial knowledge graph in the round of incremental update by using each piece of incremental data in the current incremental dataset; and
updating the initial knowledge graph by using an incremental entity linking result.

The incremental update condition includes one of the following: A predetermined period arrives, and a quantity of pieces of service data generated during the round of incremental update reaches a predetermined quantity.

In an embodiment, when the round of incremental update is not a first round of incremental update, the update unit 502 is further configured to:
obtain each real-time update result obtained based on a real-time update operation performed after the preset incremental update condition is met in a previous round of incremental update; and
update the initial knowledge graph in the round of incremental update based on each real-time update result.

The entity description information can include at least one of attribute information and connection information.

The feature vector can include one of the following or a vector obtained by performing embedding on a plurality of items in the following: a text semantic vector, a trajectory vector, a graph structure vector, and a graph representation vector.

In an embodiment, a real-time entity linking process is completed by using an online search engine, and updating a current knowledge graph based on real-time entity linking is completed by using an online graph storage engine; and the update unit 502 is configured to update the initial knowledge graph by using the incremental entity linking result in the following manner:
synchronizing the incremental entity linking result to the online search engine and the online graph storage engine by using a data dump mechanism, to replace each real-time entity linking result generated during the round of incremental update with the incremental entity linking result, so as to update the initial knowledge graph by using the incremental entity linking result.

When a second service subject involved in incremental data does not have a corresponding node in the initial knowledge graph in the round of incremental update, the incremental update operation further includes:
adding a second node corresponding to the second service subject to the initial knowledge graph in the round of incremental update; and
performing incremental entity linking based on a knowledge graph obtained after the second node is added.

In an embodiment, when the round of incremental update is a first round of incremental update, a first real-time update operation in the round of incremental update is:
updating the initial knowledge graph in the round of incremental update by using the received service data.

It should be noted that the apparatus 500 shown in FIG. 5 corresponds to the method described in FIG. 4, and corresponding descriptions in the method embodiment in FIG. 4 are also applicable to the apparatus 500. Details are not described herein again.

According to an embodiment in another aspect, a computer-readable storage medium is further provided. The computer-readable storage medium stores a computer program. When the computer program is executed in a computer, the computer is enabled to perform the method described with reference to FIG. 3, FIG. 4, or the like.

According to an embodiment in still another aspect, a computing device is further provided, and includes a memory and a processor. The memory stores executable code, and when the processor executes the executable code, the method described with reference to FIG. 3, FIG. 4, or the like is implemented.

A person skilled in the art should be aware that in the above-mentioned one or more examples, the functions described in the embodiments of this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of the technical concepts of this specification are further described in detail in the above-mentioned specific implementations. It should be understood that the above-mentioned descriptions are merely specific implementations of the technical concepts of this specification, but are not intended to limit the protection scope of the technical concepts of this specification. Any modification, equivalent replacement, improvement, or the like made based on the technical solutions of the embodiments of this specification shall fall within the protection scope of the technical concepts of this specification.

1. A method for updating a knowledge graph, wherein the method comprises performing a plurality of rounds of incremental update on a knowledge graph, wherein one round of incremental update comprises:
obtaining an initial knowledge graph in the round of incremental update; and
performing an update step that comprises a repeatedly performed real-time update operation and an incremental update operation in a case in which a preset incremental update condition is met, wherein the real-time update operation comprises: updating, in response to receiving new service data, an updated knowledge graph in a previous real-time update operation by using the received service data, and the incremental update operation comprises: updating the initial knowledge graph by using service data generated during the round of incremental update, to use an updated knowledge graph as an initial knowledge graph in a next round of incremental update.

2. The method according to claim 1, wherein the real-time update operation and the incremental update operation each comprise the following entity linking process: determining whether there are at least two nodes that correspond to service subjects that have the same characteristic; and
when there are at least two nodes that correspond to service subjects that have the same characteristic, the following entity normalization process is further performed for an entity linking result: combining nodes that have the same characteristic into one node, and superposing corresponding entity description information of the nodes that have the same characteristic as entity description information of the combined node.

3. The method according to claim 1, wherein
when the round of incremental update is a first round of incremental update, the initial knowledge graph in the round of incremental update is obtained by performing entity normalization based on an entity linking result of a knowledge graph constructed by using full service data; or
when the round of incremental update is not a first round of incremental update, the initial knowledge graph in the round of incremental update is obtained by performing entity normalization based on an incremental entity linking result of an initial knowledge graph in a previous round of incremental update.

4. The method according to claim 3, wherein the full entity linking result of the knowledge graph constructed by using full service data is obtained in the following manner:
for nodes in the knowledge graph constructed by using full service data, separately obtaining entity description information corresponding to the nodes;
extracting feature vectors respectively corresponding to the nodes based on the entity description information respectively corresponding to the nodes;
detecting a similarity between pairwise nodes based on pairwise feature vectors; and
identifying, based on whether a similarity between the pairwise feature vectors meets a predetermined homogeneity condition, whether the corresponding pairwise nodes have the same characteristic.

5. The method according to claim 2, wherein the initial knowledge graph comprises a first node, first service data for the first node is currently received new service data, and updating, in response to generating new service data in a current service, an updated knowledge graph in a previous real-time update operation by using the received service data comprises:
updating first entity description information of the first node by using the first service data;
extracting a first feature vector from updated first entity description information;
comparing similarities that are in a one-to-one correspondence and that are between the first feature vector and other feature vectors of other nodes;
obtaining, based on whether the similarities meet a predetermined homogeneity condition, a real-time entity linking result indicating whether there is another node that has the same characteristic as the first node; and
updating the updated knowledge graph in the previous real-time update operation based on the real-time entity linking result.

6. The method according to claim 2, wherein the method further comprises:
adding currently received new service data to a current incremental dataset as incremental data; and
updating the initial knowledge graph by using service data generated during the round of incremental update comprises:
performing incremental entity linking on the initial knowledge graph in the round of incremental update by using each piece of incremental data in the current incremental dataset; and
updating the initial knowledge graph by using an incremental entity linking result.

7. The method according to claim 1, wherein the incremental update condition comprises: a predetermined period arrives or a quantity of pieces of service data generated during the round of incremental update reaches a predetermined quantity.

8. The method according to claim 1, wherein when the round of incremental update is not a first round of incremental update, the update step further comprises:
obtaining each real-time update result obtained based on a real-time update operation performed after the preset incremental update condition is met in a previous round of incremental update; and
updating the initial knowledge graph in the round of incremental update based on each real-time update result.

9. The method according to claim 2, wherein the entity description information comprises at least one of attribute information and connection information.

10. The method according to claim 2, wherein the feature vector comprises one of the following or a vector obtained by performing embedding on a plurality of items in the following: a text semantic vector, a trajectory vector, a graph structure vector, and a graph representation vector.

11. The method according to claim 6, wherein a real-time entity linking process is completed by using an online search engine, and updating a current knowledge graph based on real-time entity linking is completed by using an online graph storage engine; and updating the initial knowledge graph by using an incremental entity linking result comprises:
synchronizing the incremental entity linking result to the online search engine and the online graph storage engine by using a data dump mechanism, to replace each real-time entity linking result generated during the round of incremental update with the incremental entity linking result, so as to update the initial knowledge graph by using the incremental entity linking result.

12. The method according to claim 2, wherein when a second service subject involved in incremental data does not have a corresponding node in the initial knowledge graph in the round of incremental update, the incremental update operation further comprises:
adding a second node corresponding to the second service subject to the initial knowledge graph in the round of incremental update; and
performing incremental entity linking based on a knowledge graph obtained after the second node is added.

13. The method according to claim 1, wherein when the round of incremental update is a first round of incremental update, a first real-time update operation in the round of incremental update is:
updating the initial knowledge graph in the round of incremental update by using the received service data.

14. (canceled)

15. A non-transitory computer-readable storage medium, wherein the computer-readable storage medium stores a computer program, and when the computer program is executed in a computer, causes the computer to perform a plurality of rounds of incremental update on a knowledge graph, wherein one round of incremental update comprises:
obtaining an initial knowledge graph in the round of incremental update; and
performing an update step that comprises a repeatedly performed real-time update operation and an incremental update operation in a case in which a preset incremental update condition is met, wherein the real-time update operation comprises: updating, in response to receiving new service data, an updated knowledge graph in a previous real-time update operation by using the received service data, and the incremental update operation comprises: updating the initial knowledge graph by using service data generated during the round of incremental update, to use an updated knowledge graph as an initial knowledge graph in a next round of incremental update.

16. A computing device, comprising a memory and a processor, wherein the memory stores executable code, and when the processor executes the executable code, causes the processor to perform a plurality of rounds of incremental update on a knowledge graph, wherein one round of incremental update comprises:
obtaining an initial knowledge graph in the round of incremental update; and
performing an update step that comprises a repeatedly performed real-time update operation and an incremental update operation in a case in which a preset incremental update condition is met, wherein the real-time update operation comprises: updating, in response to receiving new service data, an updated knowledge graph in a previous real-time update operation by using the received service data, and the incremental update operation comprises: updating the initial knowledge graph by using service data generated during the round of incremental update, to use an updated knowledge graph as an initial knowledge graph in a next round of incremental update.

17. The computing device according to claim 16, wherein the real-time update operation and the incremental update operation each comprise the following entity linking process: determining whether there are at least two nodes that correspond to service subjects that have the same characteristic; and
when there are at least two nodes that correspond to service subjects that have the same characteristic, the following entity normalization process is further performed for an entity linking result: combining nodes that have the same characteristic into one node, and superposing corresponding entity description information of the nodes that have the same characteristic as entity description information of the combined node.

18. The computing device according to claim 16, wherein
when the round of incremental update is a first round of incremental update, the initial knowledge graph in the round of incremental update is obtained by performing entity normalization based on an entity linking result of a knowledge graph constructed by using full service data; or
when the round of incremental update is not a first round of incremental update, the initial knowledge graph in the round of incremental update is obtained by performing entity normalization based on an incremental entity linking result of an initial knowledge graph in a previous round of incremental update.

19. The computing device according to claim 18, wherein the full entity linking result of the knowledge graph constructed by using full service data is obtained in the following manner:
for nodes in the knowledge graph constructed by using full service data, separately obtaining entity description information corresponding to the nodes;
extracting feature vectors respectively corresponding to the nodes based on the entity description information respectively corresponding to the nodes;
detecting a similarity between pairwise nodes based on pairwise feature vectors; and
identifying, based on whether a similarity between the pairwise feature vectors meets a predetermined homogeneity condition, whether the corresponding pairwise nodes have the same characteristic.

20. The computing device according to claim 17, wherein the initial knowledge graph comprises a first node, first service data for the first node is currently received new service data, and updating, in response to generating new service data in a current service, an updated knowledge graph in a previous real-time update operation by using the received service data comprises:
updating first entity description information of the first node by using the first service data;
extracting a first feature vector from updated first entity description information;
comparing similarities that are in a one-to-one correspondence and that are between the first feature vector and other feature vectors of other nodes;
obtaining, based on whether the similarities meet a predetermined homogeneity condition, a real-time entity linking result indicating whether there is another node that has the same characteristic as the first node; and
updating the updated knowledge graph in the previous real-time update operation based on the real-time entity linking result.

21. The computing device according to claim 17, wherein the computing device further causes the processor to:
adding currently received new service data to a current incremental dataset as incremental data; and
updating the initial knowledge graph by using service data generated during the round of incremental update comprises:
performing incremental entity linking on the initial knowledge graph in the round of incremental update by using each piece of incremental data in the current incremental dataset; and
updating the initial knowledge graph by using an incremental entity linking result.
